(19) United States
(12) Patent Application Publication
(10) Pub. No.: US 2008/0203364 A1
(43) Pub. Date: Aug. 28, 2008

(54) Method to Improve Dielectric and/or Dissipaton Factors of Flame Retardant Properties and Use Thereof

(75) Inventor: Kimberly A. Maxwell, Baton Rouge, LA (US)

Correspondence Address: ALBEMARLE CORPORATION;PATENT DEPARTMENT, 451 FLORIDA STREET, BATON ROUGE, LA, 70801, US

(73) Assignee: Albemarle Corporation, Baton Rouge, LA (US)

(21) Appl. No.: 11/994,892

(22) PCT Filed: Jul. 5, 2006
(86) PCT No.: PCT/US06/26656

§ 371 Date: Jan. 7, 2008

Related U.S. Application Data
(60) Provisional application No. 60/697,705, filed on Jul. 5, 2005.

(51) Int. Cl. C09K 21/00; C09K 21/14

(52) U.S. Cl. 252/601; 524/1

(57) ABSTRACT

The present invention related to a method for producing submicron-sized flame retardant compositions having improved dielectric constant and/or dissipation factors.

### FIELD OF THE INVENTION

The present invention related to a method for producing submicron-sized flame retardant compositions. More particularly, the present invention relates to a method for producing submicron-sized flame retardant compositions having improved dielectric constant and/or dissipation factors.

### BACKGROUND OF THE INVENTION

With the passage of time, the demand for smaller and smaller electronic devices has increased. Further, the demand for increased speed and frequency operation ranges from these electronic devices has also increased. These demands have led to smaller electronic parts and smaller electronic circuit boards on which these parts are mounted.

Electronic circuit boards, or printed wiring boards as they are commonly called, are generally made up of layers that include copper skeleton materials and resin materials such as polyimides, cyanate esters, unsaturated hydrocarbons, etc., which act as insulating materials. These resin materials also typically contain flame retardant compositions to improve the printed wiring boards' resistance to fires. During their use, electronic parts typically undergo transmission loss, known as dissipation loss or factor, and this transmission loss is undesirable because it results in energy waste from the electronic parts in the form of heat and can result in heat buildup in the electronic part. In order to reduce transmission loss, it is necessary to lower the dielectric constant and dielectric loss tangent. Further, electronic parts are also selected based on their dielectric constant, or the ability to store an electrical charge. In most applications in the high speed and/or high frequency areas, electronic parts that possess low dielectric constants and/or dissipation factors are desired. Thus, there has been a push in the electronics industry to produce electronic parts and electronic components and printed wiring boards with reduced dielectric constants and dissipation factors.

In this regard, a flame retardant composition incorporated into the resin used to create higher speed, higher frequency printed wiring boards, whether flexible, rigid, or otherwise, should also posses a reduced dielectric constant and/or dissipation factor when compared to flame retardant compositions used in this and other applications with lower dielectric and dissipation factor requirements. Thus, there is a need in the art for flame retardant compositions and methods of making the same that posses these qualities.

### SUMMARY OF THE INVENTION

The figure is a graph depicting the particle size data for various grinding times, as indicated in the Figure.

### SUMMARY OF THE INVENTION

The present invention relates to a method for making flame retardants with improved dielectric and/or dissipation factors. The method comprises:
a) combining a flame retardant composition, a liquid, and optionally a surfactant to form a suspension;
b) grinding said suspension under effective grinding conditions thereby producing a ground product comprising a submicron flame retardant product having an average particle size in the range of about 100 nm to about 800 nm and said liquid, wherein said effective conditions are those conditions under which at least a portion of any impurities present in the flame retardant composition are extracted into the liquid;
c) separating the submicron flame retardant product and liquid; and
d) recovering the submicron flame retardant product.

### DETAILED DESCRIPTION OF THE INVENTION

The present invention relates to a method for making flame retardants with improved dielectric and/or dissipation factors. In the practice of the present invention, a flame retardant composition is combined with a liquid to form a suspension. Flame retardant compositions suitable for use in the present invention include any and all flame retardants used in the production of printed wiring boards. Non-limiting examples of suitable flame retardant compositions include Saytex® 8010 and Saytex® BT-93W, both available commercially from the Albemarle Corporation. It is preferred that the flame retardant be one that is brominated. In some embodiments, it is within the scope of the present invention that the flame retardant further contain at least one of phosphorus, nitrogen, aluminum, magnesium, or silicon.

Liquids suitable for use herein can be selected from water; organic solvents such as toluene, xylene, acetone; alcohols such as isopropanol; and the like. It should be noted that these liquids are not effective at solubilizing the flame retardant and are selected based on this property. Thus, combining the liquid and flame retardant creates a suspension, i.e. the flame retardant composition is suspended in the liquid.

Optionally, the liquids may be combined with surfactants to boost the performance of the grinding. Suitable surfactants can be any known in the art to boost the effectiveness of grinding operations that produce submicron particles, i.e. ball grinding, etc. Non-limiting examples of suitable surfactants include those marketed commercially under the name Solsperse® and Disperbyk®.

The suspension is ground under effective grinding conditions thereby producing a ground product comprising a submicron flame retardant product having an average particle size in the range of from about 100 nm to about 800 nm, preferably ranging from about 100 nm to about 500 nm and the liquid. The method by which the suspension is ground can be selected from any suitable wet-grinding technique such as ball-grinding. Ball grinding is the preferred method, and typically involves using a circulating system containing small glass, ceramic, polyurethane, or metal beads as small as 0.1 microns to grind particles into smaller particles.

Effective grinding conditions are those conditions under which at least a portion of any impurities present in the flame retardant composition are extracted into the liquid. These conditions generally include temperatures ranging from about 10° C. to about 80° C., preferably from about 20° C. to about 40° C. Effective grinding conditions also include grinding chamber pressures ranging from about 0.5 bar to about 10 bar, preferably ranging from about 0.5 bar to about 1.5 bar. While not wishing to be bound by theory, the inventors hereof believe that all flame retardant compositions contain a level of impurities that do not affect the performance of the flame retardant, but which do negatively affect the dielectric constant and/or dissipation factor of the flame retardant. The inventors hereof believe these impurities are typically organic and or inorganic compounds such as trace amounts of the compounds used to prepare the flame retardant composition, by-products resulting from the formation reaction, color bodies, etc. Thus, the grinding of the suspension is conducted under conditions effective at extracting at least a portion, preferably substantially all, of any impurities present in the flame retardant composition therefrom.

The ground product is then separated into the submicron flame retardant product and liquid. The method by which the submicron flame retardant product and liquid are separated is not critical to the instant invention and can be selected from any techniques known to be effective at separating submicron-sized particles from liquids. Non-limiting examples of suitable techniques include filtration, decantation, evaporation, distillation, and the like, preferably filtration and decantation.

It should be noted that in some embodiments, only a portion of the liquid is removed from the ground product, thus producing a suspension comprising the flame retardant product and liquid. This suspension can then be formulated into a thermoset product by blending with a suitable resin. It should be noted that in this embodiment, the liquid used ion the grinding must be one that is compatible with the resin used in producing the thermoset product. Non-limiting examples of this embodiment include, if toluene is used as a solvent in the production of the thermoset product, then the liquid used in the grinding of the flame retardant will be toluene.

The submicron flame retardant composition is recovered or further processed in a resin formulation. This flame retardant composition possesses dielectric constants and or dissipation factors superior, i.e. lower, to those of the initial flame retardant composition. The dielectric constant and/or dissipation factor of the submicron flame retardant is generally about 0.01 lower than that of the initial flame retardant, preferably about 0.01% to about 99.99% lower. In some embodiments, the dielectric constant and dissipation factor are in the range of from about 1% to about 5% lower than that of the initial flame retardant; in other embodiments, in the range of from about 1% to about 10% lower than that of the initial flame retardant; in other embodiments in the range of from about 1% to about 15% lower than that of the initial flame retardant; in other embodiments in the range of from about 1% to about 20% lower than that of the initial flame retardant; in other embodiments in the range of from about 1% to about 30% lower than that of the initial flame retardant; in other embodiments in the range of from about 1% to about 40% lower than that of the initial flame retardant; in other embodiments in the range of from about 1% to about 50% lower than that of the initial flame retardant; in other embodiments in the range of from about 1% to about 75% lower than that of the initial flame retardant.

The above description is directed to several means for carrying out the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, when discussing the dielectric and/or dissipation factor, it is contemplated that both or either be within the range of from about 5% to about 50%, within the range of from about 15% to about 30%, within the range of from about 5% to about 75% to about 99%, within the range of from about 0.01% to about 5%, etc. The following examples will illustrate the present invention, but are not meant to be limiting in any manner.

### EXAMPLES

In order to prove the effectiveness of the present invention, Saytex® BT-93W flame retardant having a dielectric constant of 1.42 and a dissipation factor of 0.42, as measured on the dry powder by MET Laboratories, Inc., was wet-ground using a ball grinder.

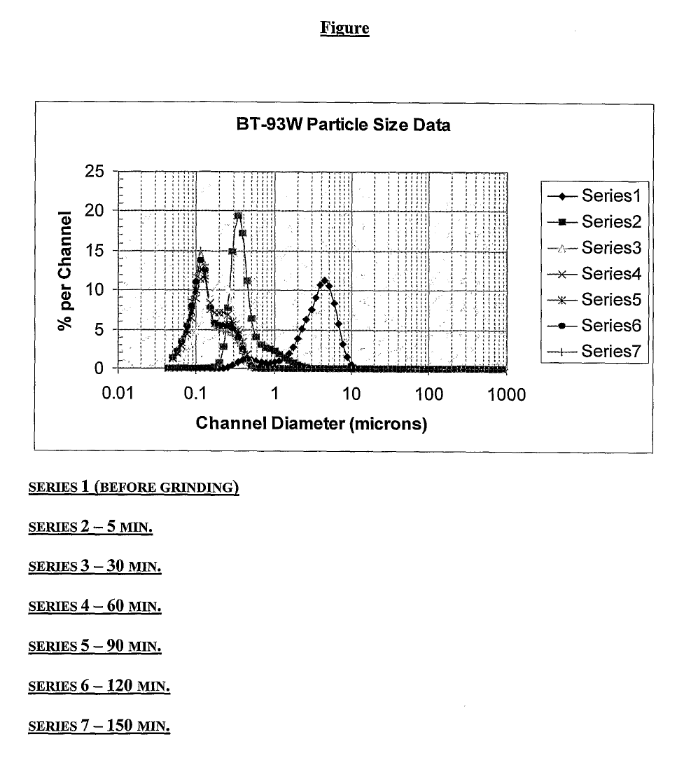

1 kg of Saytex® BT-93W was mixed with 2 kg of acetone and placed in a Netzsch Fine Particle Technology, LLC LS 1 Zeta ball grinding apparatus, which contained 460 ml of 0.2 mm ceramic bead grinding media. The cycle time for the flame retardant was about 8 minutes. After the first five minutes of grinding, the viscosity of the materials in the grinding apparatus appeared to increase. After about 40 minutes of grinding, 300 g of acetone was added to lower the viscosity of the circulating paste. After about 90 minutes of grinding, 300 g of acetone was added to decrease viscosity. After 120 minutes of grinding, 1 L of acetone and 150 g of isopropyl alcohol was added to minimize flocculation and improve viscosity. The data in Table 1 show that mean particle size can be targeted based on grinding time. The plots in FIG. 1 show that the particle size distribution is also influenced by grinding time and appears to level off between 60 and 90 minutes of grinding time. These results could possibly be improved by decreasing the suspension viscosity by better choice of liquid medium, addition of effective surfactants or dispersing agents, increasing grinding temperature, decreased cycle time, etc. The grinding times, etc. are contained in Table 1, below.

TABLE 1

| Mill size | LS 1 Zeta | | | | | |
|---|---|---|---|---|---|---|
| shaft | 55 | | | | | |
| chamber | 55 | | | | | |
| screen size | 0.06 | | | | | |
| pump type | hose (Si) | | | | | |
| motor Hp | 5 | | | | | |
| Motor kW | 3.7 | | | | | |
| FLA | 6.5 | | | | | |
| Mill Volume | 0.54 | | | | | |
| Shaft Dia. | 74 | | | | | |
| No Load | 0.8 | | | | | |
| solvent | acetone | | | | | |
| notes | viscosity build within 5 minutes | | | | | |
| Recirc. Time (min) | 0 | 30 | 60 | 90 | 120 | 150 |
| Media type | YTZ | | | | | |
| media size (mm) | 0.2 | | | | | |
| media charge (mL) | 460 | | | | | |
| sp. Gravity | 1 | | | | | |
| solids (%) | 1.1 | | | | | |
| solvent (%) | 2 | +300 g | | +300 g | +1 L, 150 g IPA | |
| batch size (kg) | 3.1 | 3.1 | 3.4 | 3.4 | 3.7 | 4.6 |
| chamber pressure (Bar) | 0.5 | 1.3 | 1.2 | 1.3 | 1.3 | 0.8 |
| Power consump. (kW) | 1.7 | 1.7 | 1.5 | 1.5 | 1.5 | 1.5 |
| Agitator speed (rpm) | 2640 | 3050 | 2930 | 2943 | 2945 | 2841 |
| recirc. Rate (kg/min) | 0.48 | 0.48 | 0.4 | 0.4 | 0.4 | 0.45 |
| pump rpm | 160 | 160 | 160 | 160 | 160 | 160 |
| outlet temp. (deg C.) | 23 | 41 | 40 | 41 | 40 | 37 |
| chill water in temp (deg C.) | 4 | 4 | 4 | 4 | 4 | 4 |
| chill water out temp (deg C.) | 5 | 7 | 7 | 7 | 7 | 7 |
| chill water flow (L/min) | 12 | 12 | 12 | 12 | 12 | 12 |
| Outlet viscosity (Cps) | | >20,000 | >20,000 | >20,000 | >20,000 | >20,000 |

The grinding of the flame retardant continued for about 60 minutes for a total grinding time of about 150 minutes. At various time intervals, the particle diameters were analyzed using a Horiba laser light scattering diffractometer. The results of these measurements are contained in Table 1, below.

After about 150 minutes, the grinding was ceased. The contents of the grinding apparatus were removed, and the acetone solvent was decanted. The acetone had turned orange in color and was concentrated by evaporation and analyzed via gas chromatography (“GC”) and mass spectral (“MS”) analysis. The GC/MS analysis revealed the presence of tetrabromophthalic anhydride, tribromophthalimide, and other brominated organic impurities. Silver nitrate titration (see Albemarle Analytical Method attached below—AAM ) was also used to determine if any ionic bromide impurities were present in the orange recovered solvent. The technique typically involves placing about 3 grams of the orange recovered solvent in 150 ml of deionized water and acidifying this mixture with about 5 ml of a solution containing 50 wt. % nitric acid and 50 wt. % water. The sample was titrated to the potentiometric end point using 0.01N silver nitrate. This analysis indicated that 96 ppm bromide ions were present in the orange recovered solvent.

The flame retardant particles were then analyzed to determine the dielectric constant and dissipation factor. The submicron flame retardant particles had a mean particle diameter of about 120 nm, as indicated in Table 2, below.

What is claimed:

1) A method for making flame retardants with improved dielectric and/or dissipation factors comprising:
a) combining a flame retardant composition, a liquid, and optionally a surfactant to form a suspension;
b) grinding said suspension under effective grinding conditions thereby producing a ground product comprising a submicron flame retardant product having an average particle size in the range of about 100 nm to about 800 nm and said liquid, wherein said effective conditions are those conditions under which at least a portion of any impurities present in the flame retardant composition are extracted into the liquid;
c) separating the submicron flame retardant product and liquid.

2) recovering the submicron flame retardant product. The method according to claim 1 wherein said flame retardant compositions is selected from those flame retardant compositions suitable for use in the production of printed wiring boards.

3) The method according to claim 2 wherein said flame retardant composition is brominated.

4) The method according to claim 1 wherein said liquid is selected from water; aromatic organic solvents such as toluene, xylene, acetone; alcohols such as isopropanol; and
the like.

5) The method according to claim 3 wherein said liquid is selected from organic solvents.

6) The method according to claim 1 wherein said submicron flame retardant product has an average particle size in the range of about 100 nm to about 500 nm.

7) The method according to claim 5 wherein said submicron flame retardant product has an average particle size in the range of about 100 nm to about 500 nm.

8) The method according to claim 1 wherein said submicron flame retardant product and said liquid are separated by a method selected from filtration, decantation, evaporation, distillation, and the like.

9) The method according to claim 1 wherein the dielectric constant of the submicron flame retardant is about 0.01% lower than that of the initial flame retardant.

10) The method according to claim 7 wherein the dielectric constant of the submicron flame retardant is about 0.01% to about 99.99% lower than that of the initial flame retardant.

11) The method according to claim 1 wherein said flame retardant particle and said liquid are combined with a surfactant.

12) The method according to claim 1 wherein said flame retardant particle and said liquid are combined with a dispersant.

13) The method according to claim 1 wherein said flame retardant particle and said liquid are combined with a dispersant and a surfactant.

14) The method according to any of the preceding claims wherein said submicron flame retardant is incorporated into a resin formulation.

15) The method according to claim 14 wherein said resin is one that is suitable for use in the manufacture of printed wiring boards.

16) The resin formulation of any of claims 14 or 15.

17) A method for making flame retardants with improved dielectric and/or dissipation factors comprising:
a) combining a flame retardant composition, a liquid, and optionally a surfactant to form a suspension;
b) grinding said suspension under effective grinding conditions thereby producing a ground product comprising a submicron flame retardant product having an average particle size in the range of about 100 nm to about 800 nm and said liquid, wherein said effective conditions are those conditions under which at least a portion of any impurities present in the flame retardant composition are extracted into the liquid;
c) removing at least a portion of the liquid from the ground product thereby producing a product suspension comprising the submicron flame retardant product and at least a portion of the liquid.

18) The method according to claim 17 wherein said product suspension is formulated into a thermoset product by blending it with a suitable resin.

19) The resin formulation of any of claims 17 or 18.
